(19) United States
(12) Patent Application Publication
(10) Pub. No.: US 2010/0312500 A1
(43) Pub. Date: Dec. 9, 2010

(54) Array of Electromagnetic Radiation Sensors with On-Chip Processing Circuitry

(76) Inventors: Stephen Morgan, Nottingham (GB); Barrie Hayes-Gill, Nottingham (GB)

Correspondence Address: NIXON & VANDERHYE, PC, 901 NORTH GLEBE ROAD, 11TH FLOOR, ARLINGTON, VA, 22203, US

(21) Appl. No.: 12/669,848

(22) PCT Filed: Jul. 21, 2008
(86) PCT No.: PCT/GB2008/002503

§ 371 Date: Apr. 23, 2010

(30) Foreign Application Priority Data
Jul. 20, 2007 (GB) 0714192.2

(51) Int. Cl. G06F 15/00; G01F 1/66

(52) U.S. Cl. 702/49; 702/189

(57) ABSTRACT

A system comprises an illumination system to illuminate a sensor device with a reference beam of electromagnetic radiation and with electromagnetic radiation from a subject. A Doppler shift of the radiation from the subject occurs, if the subject is moving, vibrating, or is a flowing fluid. The sensor device provides an array of electromagnetic radiation sensors and has processing circuitry integrated into the sensor device to process the output of the sensors to provide the output of the sensor device. The processing circuitry is operable to provide, for each operative sensor, a value calculated from the Doppler shift of the radiation from the subject at the corresponding position at the subject, and to provide the calculated values as the processed output. This reduces the data rate required at the output of the sensor device, and allows the output to be used to form an image on a display representing the movement, vibration or flow of the subject.

The present invention relates to apparatus and methods for imaging, and in particular, but not exclusively, to apparatus and methods for imaging flows and vibrations.

The measuring and imaging of flows and vibrations is important in many applications. For example, flow applications include air flow measurements in aerodynamic design, fluid flow in pipes, mixing in combustion engines, mixing of supercritical fluids in pharmaceutical production, formation of tissue engineered structures and the parallel monitoring of traffic flow. Imaging of vibration is important in many mechanical design applications as artificial identification systems, for civil engineering structures, aircraft fuselage integrity, engine housing assessment, automobile vibrations to name but a few.

Embodiments of the invention provide a system comprising:
a sensor device providing an array of electromagnetic radiation sensors;
processing circuitry integrated in the sensor device and operable to process the output of the sensors to provide the output of the sensor device;
an illumination system operable to illuminate the sensors with a reference beam of electromagnetic radiation and with electromagnetic radiation which has interacted with a subject;
the processing circuitry being operable to provide, for each operative sensor, a value calculated from the Doppler shift of the radiation from the subject at the corresponding position at the subject, and to provide the calculated values as the processed output.

The radiation may be reflected or transmitted by the subject.

The processing circuitry may include a plurality of processing circuits operable to process the output of a respective sensor or group of sensors. Each processing circuit may be operable to process the output of a line of sensors in a rectilinear array of sensors. Alternatively, each processing circuit may be operable to process the output of a respective sensor.

The processing circuitry may be operable to calculate a velocity, flow rate or vibration amplitude of the subject at the position corresponding with each operative sensor.

The processing circuitry may be operable to calculate values from the phase or amplitude sensed by the sensors. The processing circuitry may be operable to calculate values by a Fast Fourier Transform technique.

The processing circuitry may provide signal processing. The signal processing may be wholly or partly analogue. The signal processing may be wholly or partly digital.

The sensors may be arranged as a line of sensors, the processed output representing values along the corresponding line at the subject. Alternatively, the sensors may be arranged as a two-dimensional array; the processed output representing values over a corresponding area of the subject.

The processing circuitry may comprise a hysteretic differential amplifier, high pass filter, lock-in detector, frequency weighted filter or quadrature demodulator. A respective hysteretic differential amplifier, high pass filter, lock-in detector, frequency weighted filter or quadrature demodulator may be provided for each sensor. The processing circuitry may provide averaging.

The sensor device may be fabricated from silicon, InGaAs or HgCdTe.

The system may further comprise an image processor operable to receive the processed output and to provide an image representing the calculated values. The calculated value of each sensor may be used to provide a respective pixel of the image.

Embodiments of the invention also provide a method comprising:
providing a sensor device having an array of electromagnetic radiation sensors;
illuminating the sensors with a reference beam of electromagnetic radiation and with electromagnetic radiation which has interacted with a subject;
processing the output of the sensors to provide the processed output of the sensor device, by means of processing circuitry integrated in the sensor device and operable to provide, for each operative sensor, a value calculated from the Doppler shift of the radiation from the subject at the corresponding position at the subject, and to provide the calculated values as the processed output.

Preferably, a plurality of processing circuits are used to process the output of a respective sensor or group of sensors. Each processing circuit may be used to process the output of a line of sensors in a rectilinear array of sensors.

Alternatively, each processing circuit may be used to process the output of a respective sensor.

The processing circuitry may be used to calculate a velocity, flow rate or vibration amplitude of the subject at the position corresponding with each operative sensor.

The processing circuitry may be used to calculate values from the phase or amplitude sensed by the sensors. The processing circuitry may be used to calculate values by a Fast Fourier Transform technique.

The processing circuitry may be used to provide signal processing. The signal processing may be wholly or partly analogue. The signal processing may be wholly or partly digital.

The sensors may be arranged as a line of sensors, the processed output representing values along the corresponding line at the subject. Alternatively, the sensors may be arranged as a two-dimensional array, the processed output representing values over a corresponding area of the subject.

The processing circuitry may comprise a hysteretic differential amplifier, high pass filter, lock-in detector, frequency weighted filter or quadrature demodulator. A respective hysteretic differential amplifier, high pass filter, lock-in detector, frequency weighted filter or quadrature demodulator may be provided for each sensor. The processing circuitry may provide averaging.

The sensor device may be fabricated from silicon, InGaAs or HgCdTe.

The processed output may be further processed to provide an image representing the calculated values. The calculated value of each sensor may be used to provide a respective pixel of the image.

Embodiments of the present invention will now be described in more detail, by way of example only, and with reference to the accompanying drawings, in which:

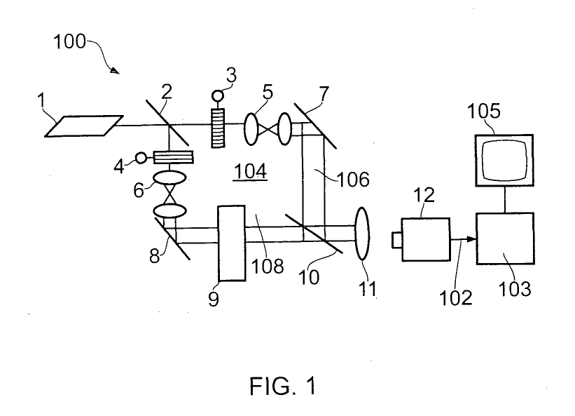

FIGS. 1 to 3 are schematic illustrations of illumination arrangements for use in example embodiments;

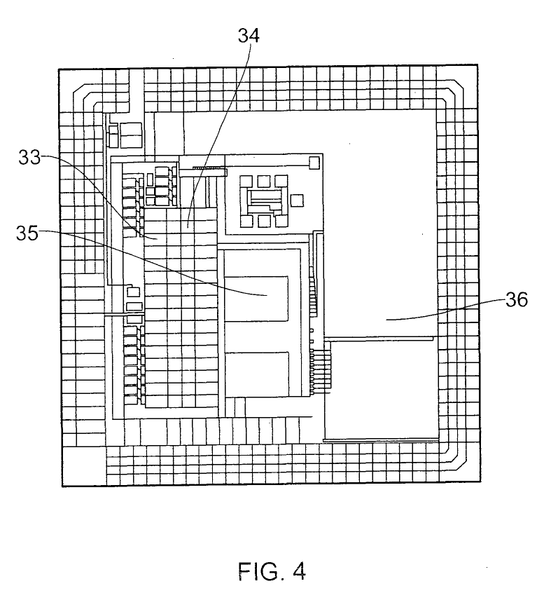

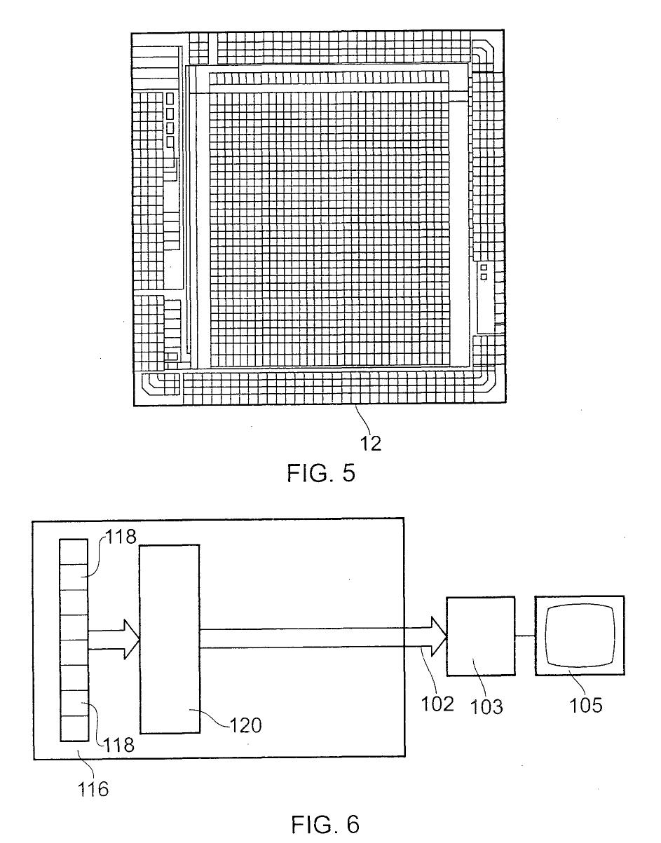

FIGS. 4 and 5 are photographic views of sensor devices built for example embodiments;

FIG. 6 is a schematic diagram of the relevant internal workings of an example of the sensor devices illustrated in FIGS. 1 to 5; and

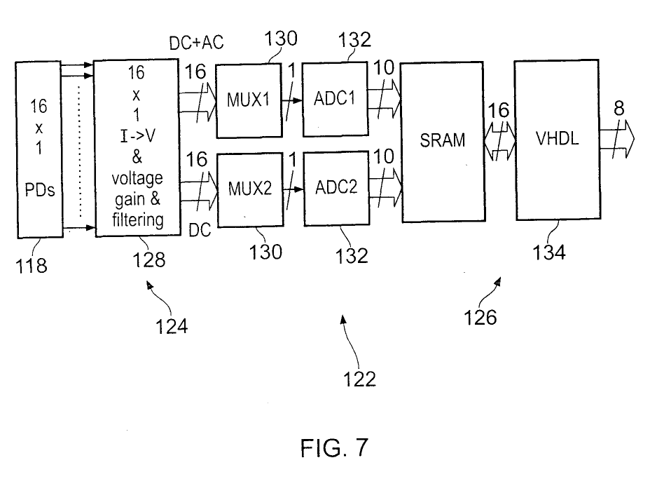

FIG. 7 corresponds with FIG. 6, showing additional detail.

The examples to be described relate to systems for the imaging of flows and vibrations. The examples involve the illumination of a subject by electromagnetic radiation (ER). The electromagnetic radiation may be visible light or may be at an invisible wavelength. In this specification, the terms electromagnetic radiation, ER and “light” are used interchangeably and none is intended to be restricted to visible light or invisible wavelengths.

ER (for example visible light but not limited to these frequencies) that interacts with a moving object undergoes a Doppler shift (i.e. a change in frequency) that is proportional to the velocity of the object. The change of frequency of an ER wave when it interacts with a moving object is the well-known Doppler effect. The frequency shift of the detected wave can be related to the velocity of the moving object;

$$Δ f = \frac{2 nv}{λ} sin ϑ$$

Where Δf is the Doppler frequency shift, n is the refractive index, v is the velocity of the target, λ is the wavelength of the illumination and θ is the angle between the illumination and the axis of motion. It should be noted that when the motion of the object is perpendicular to the illumination then no Doppler shift will occur. If the ER from the subject (the moving medium) is interfered with a reference beam which has not undergone a Doppler frequency shift, an amplitude modulated light signal is produced that contains information about the velocity of the moving medium.

Thus, the electromagnetic radiation scattered from the moving object has a Doppler frequency shift superimposed upon it. Often, as in the case of the frequencies associated with visible light (˜10¹⁵ Hz), this frequency cannot be directly detected with a conventional detector. A reference beam is therefore used in the examples to be described, to mix down the frequency to a range that is detectable by the sensor array to be described. The electric field at the sensor is composed of an electric field (Es) from the subject and an electric field (Er) from the reference. These two fields have a frequency difference that is due to the frequency shift imposed by the movement of the subject.

In examples to be described, sensor devices are used, which are integrated optical sensors (IOS). Integrated optical sensors are arrays of photodiodes with on-chip processing. The sensor provides an electrical current that is proportional to the intensity of the electric field of the incident light (current I is proportional to (Es+Er)²). The action of summing the electric fields and converting this to an intensity (squaring) results in an electrical current that has both sum and difference frequencies. The difference frequency is detectable by the sensor and is the Doppler signal of interest in the described system.

### Illumination Configuration

FIG. 1 illustrates a system 100 comprising a sensor device 12 providing an array of electromagnetic radiation sensors (to be described in more detail). The system 100 also includes processing circuitry integrated in the sensor device 12 and operable to process the output of the sensors to provide the output of the sensor device, at 102.

An illumination system 104 is operable to illuminate the sensors with a reference beam 106 of electromagnetic radiation and with electromagnetic radiation 108 reflected (in this example) from a subject (or target) 9.

The processing circuitry integrated in the sensor device 12 is operable to provide, for each operative sensor, a value calculated from the Doppler shift of the reflected radiation at the corresponding position at the subject 9, and to provide the calculated values as the processed output 102.

One example configuration using for example ER in the optical part of the electromagnetic spectrum is shown in FIG. 1. Light emerging from a laser (1) is split using a beamsplitter (2) into a probe beam 108 that interacts with the target (9) and a reference beam 106. In this example, both beams 106, 108 are passed through a component (3,4) that shifts the frequency of the light e.g. an acousto-optic modulator, but this is not essential. Frequency shifting the light enables the direction of the Doppler shift (flow direction) to be determined. Both beams are then expanded by a combination of lenses (5,6) to provide full field illumination (i.e. illumination of an area rather than a single point). The probe beam 108 then interacts with the target (9) and is frequency shifted by any motion of the target.

The probe beam 108 and reference beam 106 are then recombined by a pair of mirrors (7,8) and a beamsplitter (10). The object is imaged onto an area of the integrated optical sensor (12) using an imaging lens (11) to provide a modulated light signal proportional to the velocity of the subject 9. It should be noted that when the motion of the subject 9 is perpendicular to the illumination 108, then no Doppler shift will occur.

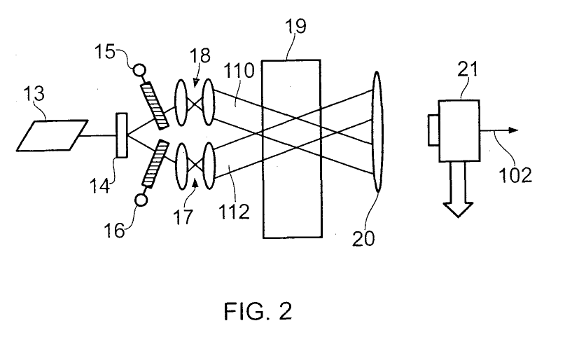

An alternative configuration is shown in FIG. 2. Light emerging from a laser (13) is split using a beamsplitter (14) into a probe beam 110 that interacts with the target 19 and a reference beam 112. Both beams are passed through a respective component (15,16) that shifts the frequency of the light. Both beams are then expanded by a respective combination of lenses (17,18) to provide full field illumination. In this configuration both beams 110, 112 interact with the target (19) and are frequency shifted by any motion of the target. The beams 110, 112 arrived at the target 19 from different directions, and as the Doppler shift is angle dependent, the two beams will be frequency shifted by different amounts. The beams are then imaged using a lens (20) onto an integrated optical sensor (21) where they interfere to present a modulated light image to the sensor. The sensor 21 may be the same as the sensor 12 of FIG. 1. This configuration is a so-called ‘common-path’ configuration and provides a robust system immune from external factors such as external differences (i.e. not related to the target under investigation) in air turbulence and vibrations between the probe and reference beams. This configuration shows transmission geometry although it will be appreciated that by moving the integrated optical sensor (21) to the opposite side of the target, Doppler shifts can be imaged in reflection geometry.

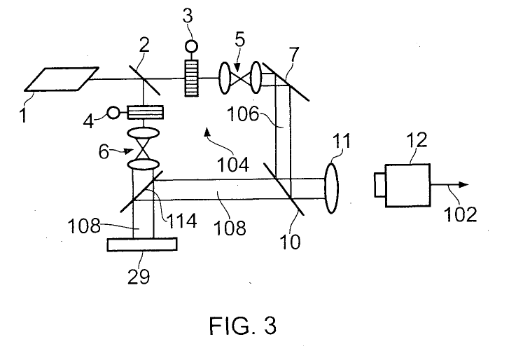

An alternative reflectance mode configuration is shown in FIG. 3. This alternative corresponds closely with the alternative of FIG. 1, and the same reference numerals are used for corresponding features. The principal difference is the inclusion of a half-silvered mirror 114. The mirror 114 and the position of the target 9 in the interferometer allows the target 9 to be imaged in reflection geometry.

In each of the example imaging configurations described above, it should be noted that;
Although laser illumination has been described, different wavelength electromagnetic radiation could be used. Alternatively illumination could be performed using for example Light Emitting Diodes (LEDs) or a white light source although in this case the pathlengths of the probe and reference beams will need to be well matched due to the short coherence length of the source.
Three example configurations have been described but other similar configurations are possible with simple rearrangement of the basic components e.g. transmission and reflection geometries.
A single or more than 2 frequency shifting elements could be used and these could all be placed in the same arm of the interferometer if more convenient. No frequency shifting elements are required, but this will not allow the direction of motion to be obtained.
A single imaging lens is shown but a combination of lenses such as a microscope or telescope configuration could be used.
Multiple integrated optical sensors could be used to provide information about the velocity of components along different spatial directions. For example three integrated optical sensors could be used to provide 3D velocity or vibration images.
An optical fibre bundle (endoscope) could be used to provide Doppler images of flows and vibrations at subjects in inaccessible locations.
The full field illumination could comprise speckle or structured illumination to eliminate crosstalk between pixels in the image.
By measuring the relative phase of the signals at displaced pixels in the array, phase Doppler velocimetry can be performed. Alternatively, two integrated optical sensors at different angles can be used to image particle size distribution. This is a full field approach of single point phase Doppler measurements.

Although directional information will be lost it is possible to produce a spatial velocity map of flows and vibration when no reference beam is used. Such a system again has many applications for full field flow and vibration assessment and offers a much simpler equipment arrangement more suitable for non-static on site inspections.

### Integrated Optical Sensor Configuration

The integrated optical sensor 12, 21 comprises a custom-made array of photodiodes with on-chip (integrated) processing. This is used to demodulate the Doppler shifted image to obtain images of velocity or vibration. Processing the Doppler image data on-chip enables high frequency Doppler signals to be processed at the pixel level. This approach allows frequencies higher than those that can be sensed by an independent sensor array and processing unit to be detected, and allows the processed data to be output from the sensor at a lower bandwidth. Transfer of the raw, unprocessed signals from the photodiode array to a separate processing unit would require a high data rate and result in a data bottleneck between the array and processing unit.

In this specification, the terms “integration” and “integrated” refer to the fabrication of multiple devices on a single semiconductor chip.

Examples of integrated optical sensors for imaging flows and vibrations are shown in FIGS. 4 and 5. FIG. 4 shows a 16×1 linear array with mixed analogue and digital processing on-chip. FIG. 5 shows a 32×32 2D imaging array with analogue signal processing at the pixel level.

As an example, the processing configuration of the 16×1 linear array sensor is shown as a block diagram in FIG. 6, and in more detail in FIG. 7.

In FIG. 6, the sensor device 12, 21 provides an array 116 which is a line of 16 electromagnetic radiation sensors 118. The sensors 118 are provided within the sensor device 12, 21 which may be fabricated using a CMOS process. The sensor device 12, 21 may be fabricated from silicon, Indium Gallium Arsenide (InGaAs), Mercury Cadmium Teluride (HgCdTe) or another semiconductor material. The choice of process will depend, at least in part, on the proposed frequency of the illuminating light, and the bandwidth of the semiconductor material, for compatability.

In this example, the sensor device 12, 21 is an integrated optical sensor (IOS). Integrated optical sensors are arrays of photodiodes with on-chip processing. We expect that Integrated optical sensors will offer advantages in terms of speed, signal to noise and dynamic range, data compression and throughput, optical geometry, size and weight and scalability. And IOS detector in its widest sense is not limited to visible light. For example a hybrid arrangement is possible of an array of ER detectors “bump bonded” at the pixel level to an array of parallel processing elements. Such an arrangement is useful for using detectors other than silicon and hence a different wavelength range of ER is possible i.e. using HgCdTe for wavelengths around ˜1.3 μm. This allows the ability of the detector to use eye safe radiation and takes full advantage of the Integrated Circuit processing for the generation of an array of parallel processing pixels. Such an approach can also be extended to much lower and higher frequencies and even to non-ER modulation, for example an array of ultrasound detectors can be bump bonded to an Integrated circuit with processing at each detector point.

The sensor device 12, 21 also includes processing circuitry 120. This is integrated into the device 12, 20, as indicated in FIG. 6. The processing circuitry 120 is connected between the sensors 118 and the device output 102. The processing circuitry 120 is operable to process the output of the sensors to provide the output of the sensor device 12, 21, at 102.

In more detail, the processing circuitry 120 is operable to make a calculation from the output of each of the sensors 118 which is in use, that is, for each operative sensor 118. A single block of circuitry 120 may serve all of the sensors 118 in turn, or there may be respective processing circuits operable to process the output of respective sensors. Other geometries could be envisaged for allowing a plurality of processing circuits to process the output of a respective sensor or group of sensors, particularly when using a rectilinear array of sensors, such as that shown in FIG. 5.

The calculation performed by the processing circuitry 120, for a particular sensor, provides a value calculated from the Doppler shift of the radiation received at the particular sensor 118 from the subject 9, 19, in conjunction with the reference beam 106, 112. The radiation received at the particular sensor 118 will have arrived from a respective position at the subject 9, 19, different to the position from which radiation arrives at other sensors 118, by virtue of the function of the imaging lenses 11, 20. Consequently, each sensor represents a pixel of an image derived from a line at the subject 9, 19, each pixel containing information about the corresponding position at the subject 9, 19. The output of each pixel is processed within the device 12, 21 by the processing circuitry 120 to recover the required value calculated from the Doppler shift of the radiation from the subject 9, 19.

It can be shown that the Doppler generated signal from the sensors 118 is a Frequency Modulated (FM) signal whose frequency is proportional to both velocity and displacement (for a vibrating object) of the moving object. The output from a sensor 118 will be the full bandwidth signal, but this is processed on chip to compute a single value from each pixel i.e. the displacement, for example. This can be achieved, for example, by counting the number of zero crossings within one Doppler cycle and scaling this by λ/4—the difference between constructive and destructive interference in a reflection geometry interferometer, where λ is the wavelength of light. By processing this signal on-chip in this way, a single value is calculated for each pixel for each Doppler cycle, and a reduced series of numbers is produced. That is, by reducing the full bandwidth output of a sensor 118 to a calculated value such as velocity, displacement, flow rate etc, the bandwidth required at the output 102 is greatly reduced. A data bottleneck does not result. This allows image data of flows and vibrations to be generated in parallel across the sensor array.

The processing circuitry 120 may be operable to calculate a velocity, flow rate or vibration amplitude of the subject 9, 19 at the position corresponding with each operative sensor 118. The processing circuitry 120 may be operable to calculate values from the phase or amplitude sensed by the sensors 118. The processing circuitry 120 may be operable to calculate values by a Fast Fourier Transform technique.

The processing circuitry 120 may provide signal processing by a wholly or partly analogue technique or buy a wholly or partly digital technique. The processing circuitry may comprise a hysteretic differential amplifier, high pass filter, lock-in detector, frequency weighted filter or quadrature demodulator. A respective hysteretic differential amplifier, high pass filter, lock-in detector, frequency weighted filter or quadrature demodulator may be provided for each sensor. The processing circuitry may provide averaging.

The output 102 from the sensor device 12, 21 may be supplied to an image processor 103 which converts the calculated value for each pixel, into a corresponding pixel image on a display 105, for viewing.

In other examples, the sensors may be arranged as a two-dimensional array as shown in FIG. 5, the processed output 102 representing values over a corresponding area of the subject 9, 19. In this example, the illumination of the array comprises electromagnetic radiation (for example visible and non-visible light) striking an area of a vibrating or flowing material. The light that emerges from this material is imaged onto the ER sensitive imaging array (by one of the arrangements described with reference to FIGS. 1 to 3, or another arrangement) and in the presence of a reference beam derived from the original source of ER. The imaging array comprises a two dimensional array of ER detectors with on-chip processing. The imaging array enables the Doppler shifts from flows and vibrations to be imaged. The on-chip processing electronics allows Doppler frequencies above the range of conventional fast read out rate cameras to be imaged. Measuring the phase of the detected field also allows full field phase Doppler to be performed allowing particle size distributions to be imaged.

Another example of the processing arrangements within the sensor device 12, 21 is illustrated in more detail in FIG. 7. Other features of the arrangement of FIG. 7 may be the same as the corresponding features of the arrangement of FIG. 6 and are therefore not described again in detail.

In the arrangement of FIG. 7, the output of the sensors 118 is processed by processing circuitry 122 to provide the output 102. The processing circuitry 122 can be divided into two main parts: an analogue front-end 124 and a digital back-end 126. All analogue and digital components are fully integrated onto the same device, which is a CMOS chip in this example. The analogue front-end 124 consists of a 16×1 linear array of “active” pixel photodiodes (PD) 118 integrated with CMOS analogue circuits 128 for signal amplification and filtering, multiplexing circuits 130 (MUX1, MUX2) and analogue to digital conversion circuits 132 (ADC1, ADC2). The digital back-end 126 is composed of filters, averaging circuits and SRAM required for the necessary subsequent signal processing. These processes may be incorporated within a processor device 134 which may be a dedicated device integrated within the device 12, 21, or a general purpose processor running under appropriate software control. In one example, the processor 134 may operate under the VHSIC hardware description language, which is a programming language allowing concurrent processes to be executed, thus mimicking parallel processing hardware and allowing the outputs from each of the sensors 118 to be processed in parallel with each other.

This example indicates the processing electronics that can be performed on the integrated optical sensor at either the pixel level or the column level or other group level, but in each case on the chip 12, 21. In the integrated optical sensor design, it should be noted that;
The processing could include analogue signal processing, digital signal processing or a mixed (analogue+digital) signal processing approach.
By incorporating appropriate multiplexers, the processing electronics could be at the column level rather than the pixel level, although this will result in a lower frequency response.
A linear photodiode array (Nx1) could be used instead of a 2D, although this would mean that scanning would need to be performed in 1 dimension to build up an image.
The processing could include a hysteretic differential amplifier (HDA) which will amplify the amplitude modulated (AC) component more than the constant background (DC component) to improve the dynamic range.
The processing could be performed using lock-in detection, a frequency weighted filter, a high pass filter centred around the frequency set by the frequency shifting elements or an quadrature (IQ) demodulator.
The processing could perform both amplitude and phase measurements so that phase Doppler measurements can be made for particle sizing applications.
The processing could also contain circuitry to perform averaging of the processed data. This will reduce noise and reduce the amount of data output from the integrated optical sensor.
While CMOS fabrication is discussed, often implemented in silicon, other semiconductor materials such as Indium Gallium Arsenide (InGaAs) and Mercury Cadmium Teluride (HgCdTe) for example can be used to change the wavelength sensitivity range.

The apparatus described has a wide range of applications such as imaging the velocity profiles of turbulent air flow, any fluid flow, mixing in combustion engines, mixing in pharmaceutical processes, blood flow imaging, mechanical vibration imaging and phase Doppler imaging for particle sizing. The arrangements described above allow an image to be formed simultaneously along a line or over an area of the subject and thus provides full field imaging, rather than simple, single point measurement. Examples of the practical use of this form of imaging may include providing an understanding of the flow of air around an automobile or the mixing process in a combustion engine. In the case of vibrometry, the ability to provide a full field spatial image or map of the vibration profile provides considerable additional information. Scanning using a single point system configuration allows an image to be built up only on a pixel by pixel basis. However, that approach is limited by the scanning rate and so does not provide real time imaging of flows and cannot provide information about rapidly changing processes.

In the examples described above, the use of an independent reference beam allows the direction of flow in the subject to be imaged. The system is not limited by a data transfer bottleneck from the sensor array, because of the processing which is conducted on-chip. This increases the maximum detectable frequency or image pixel resolution. Often the frequency of modulation resulting from Doppler techniques in vibration and flow applications is too high to be detected by conventional detectors. Here, example systems are described which can be used to image Doppler frequency shifted light in full field, because an integrated optical sensor with on-chip processing is used. This could be fabricated using a CMOS process (complementary metal oxide semiconductor) but other processes can be used, as noted above. The on-chip processing is used to prevent a data bottleneck arising at the output of the image sensor chip and allows the high frequency Doppler shifted light to be detected. This allows velocity variations across an image to be determined. In addition, measuring the phase of the detected field allows full field phase Doppler to be performed allowing particle size distributions to be imaged.

In some of the examples above, notably the example of FIG. 1, the reference beam directly illuminates the sensor, without interaction with the subject. In other examples, notably the example of FIG. 2, the reference beam interacts with the subject, but the Doppler shift of the two beams differs, by virtue of their different illumination angles. Accordingly, references herein to a “reference beam” are not restricted to arrangements in which no modification of the reference beam takes place, or in which the sensor is directly illuminated. It may be possible to arrange for the reference beam to arise naturally from the subject, for example by reflection.

The apparatus and methods described above are based on the realization that by combining an integrated optical sensor with appropriate on-chip signal processing and an ER configuration for detecting Doppler shifts, a system for imaging flows and vibrations in full-field can be obtained. The on-chip signal processing is capable of extracting in parallel useful information, e.g. flow, vibration, velocity, etc from the high frequency oscillating signals detected. The useful information is then read out from the sensor at a lower data rate. This allows full field measurements of flows at high resolution, even when the Doppler signals are oscillating at high frequency.

Many variations are modifications can be made to the apparatus and methods described above, without departing from the scope of the invention defined in the attached claims.

1. A system comprising:
a sensor device providing an array of electromagnetic radiation sensors;
processing circuitry integrated in the sensor device and operable to process the output of the sensors to provide the output of the sensor device;
and illumination system operable to illuminate the sensors with a reference beam of electromagnetic radiation and with electromagnetic radiation reflected from a subject;
the processing circuitry being operable to provide, for each operative sensor, a value calculated from the Doppler shift of the reflected radiation at the corresponding position at the subject, and to provide the calculated values as the processed output.

2. A system according to claim 1, wherein the processing circuitry includes a plurality of processing circuits operable to process the output of a respective sensor or group of sensors.

3-4. (canceled)

5. A system according to claim 1, wherein the processing circuitry is operable to calculate a velocity, flow rate or vibration amplitude of the subject at the position corresponding with each operative sensor.

6. A system according to claim 1, wherein the processing circuitry is operable to calculate values from the phase or amplitude sensed by the sensors.

7. A system according to claim 1, wherein the processing circuitry is operable to calculate values by a Fast Fourier Transform technique.

8-10. (canceled)

11. A system according to claim 1, wherein the sensors are arranged as a line of sensors, the processed output representing values along the corresponding line at the subject.

12. A system according to claim 1, wherein the sensors are arranged as a two-dimensional array, the processed output representing values over a corresponding area of the subject.

13. A system according to claim 1, wherein the processing circuitry comprises a hysteretic differential amplifier, high pass filter, lock-in detector, frequency weighted filter or quadrature demodulator.

14-16. (canceled)

17. A system according to claim 1, further comprising an image processor operable to receive the processed output and to provide an image representing the calculated values.

18. A system according to claim 17, wherein the calculated value of each sensor is used to provide a respective pixel of the image.

19. A method comprising:
providing a sensor device having an array of electromagnetic radiation sensors;
illuminating the sensors with a reference beam of electromagnetic radiation and with electromagnetic radiation reflected from a subject;
processing the output of the sensors to provide the processed output of the sensor device, by means of processing circuitry integrated in the sensor device and operable to provide, for each operative sensor, a value calculated from the Doppler shift of the reflected radiation at the corresponding position at the subject, and to provide the calculated values as the processed output.

20. A method according to claim 19, wherein a plurality of processing circuits are used to process the output of a respective sensor or group of sensors.

21-22. (canceled)

23. A method according to claim 19, wherein the processing circuitry is used to calculate a velocity, flow rate or vibration amplitude of the subject at the position corresponding with each operative sensor.

24. A method according to claim 19, wherein the processing circuitry is used to calculate values from the phase or amplitude sensed by the sensors.

25. A method according to claim 19, wherein the processing circuitry is used to calculate values by a Fast Fourier Transform technique.

26. A method according to claim 19, wherein the processing circuitry is used to provide signal processing.

27-28. (canceled)

29. A method according to claim 19, wherein the sensors are arranged as a line of sensors, the processed output representing values along the corresponding line at the subject.

30. A method according to claim 19, wherein the sensors are arranged as a two-dimensional array, the processed output representing values over a corresponding area of the subject.

31. A method according to claim 19, wherein the processing circuitry comprises a hysteretic differential amplifier, high pass filter, lock-in detector, frequency weighted filter or quadrature demodulator.

32-34. (canceled)

35. A method according to claim 19, wherein the processed output is further processed to provide an image representing the calculated values.

36. A method according to claim 35, wherein the calculated value of each sensor is used to provide a respective pixel of the image.

37-39. (canceled)
